(19) United States
(12) Patent Application Publication
(10) Pub. No.: US 2012/0327869 A1
(43) Pub. Date: Dec. 27, 2012

(54) COEXISTENCE MANAGEMENT SCHEME FOR MULTI-RADIO CO-EXISTENCE

(75) Inventors: Jibing Wang, San Diego, CA (US); Joel Benjamin Linsky, San Diego, CA (US)

(73) Assignee: QUALCOMM INCORPORATED, San Diego, CA (US)

(21) Appl. No.: 13/525,901

(22) Filed: Jun. 18, 2012

Related U.S. Application Data
(60) Provisional application No. 61/500,429, filed on Jun. 23, 2011.

(51) Int. Cl. H04W 52/04

(52) U.S. Cl. 370/329

(57) ABSTRACT

Various aspects of the disclosure provide techniques to mitigate interference on a multi-radio device by adjusting operation of multiple radio access technologies (RATs) based on communication event combinations. A coexistence manager may create a table of communication event combinations of multiple RATs that may result in cross-RAT interference. The table may include one or more potential coexistence management schemes to be applied in the event a particular communication event combination occurs. When faced with a particular communication event combination the coexistence manager may then reference the table, and apply a corresponding coexistence management scheme.

### CROSS REFERENCE TO RELATED APPLICATION

This application claims the benefit under 35 U.S.C. §119(e) to U.S. Provisional Patent Application No. 61/500,429 entitled “POWER ADJUSTMENT SCHEME BASED ON RADIO TIMING FOR MULTI-RADIO CO-EXISTENCE” filed on Jun. 23, 2011 the disclosure of which is expressly incorporated herein by reference in its entirety.

### BACKGROUND

1. Field

Aspects of the present disclosure relate generally to wireless communications systems and, more particularly, to a method for managing transmission of multiple radio access technologies.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple out (MIMO) system.

Some conventional advanced devices include multiple radios for transmitting/receiving using different Radio Access Technologies (RATs). Examples of RATs include, e.g., Universal Mobile Telecommunications System (UMTS), Global System for Mobile Communications (GSM), cdma2000, WiMAX, WLAN (e.g., WiFi), Bluetooth, LTE, and the like.

An example mobile device includes an LTE User Equipment (UE), such as a fourth generation (4G) mobile phone. Such 4G phone may include various radios to provide a variety of functions for the user. For purposes of this example, the 4G phone includes an LTE radio for voice and data, an IEEE 802.11 (WiFi) radio, a Global Positioning System (GPS) radio, and a Bluetooth radio, where two of the above or all four may operate simultaneously. While the different radios provide useful functionalities for the phone, their inclusion in a single device gives rise to coexistence issues. Specifically, operation of one radio may in some cases interfere with operation of another radio through radiative, conductive, resource collision, and/or other interference mechanisms. Coexistence issues include such interference.

This is especially true for the LTE uplink channel, which is adjacent to the Industrial Scientific and Medical (ISM) band and may cause interference therewith. It is noted that Bluetooth and some Wireless LAN (WLAN) channels fall within the ISM band. In some instances, a Bluetooth error rate can become unacceptable when LTE is active in some channels of Band 7 or even Band 40 for some Bluetooth channel conditions. Even though there is no significant degradation to LTE, simultaneous operation with Bluetooth can result in disruption in voice services terminating in a Bluetooth headset. Such disruption may be unacceptable to the consumer. A similar issue exists when LTE transmissions interfere with GPS. Currently, there is no mechanism that can solve this issue since LTE by itself does not experience any degradation

With reference specifically to LTE, it is noted that a UE communicates with an evolved NodeB (eNB; e.g., a base station for a wireless communications network) to inform the eNB of interference seen by the UE on the downlink. Furthermore, the eNB may be able to estimate interference at the UE using a downlink error rate. In some instances, the eNB and the UE can cooperate to find a solution that reduces interference at the UE, even interference due to radios within the UE itself. However, in conventional LTE, the interference estimates regarding the downlink may not be adequate to comprehensively address interference.

In one instance, an LTE uplink signal interferes with a Bluetooth signal or WLAN signal. However, such interference is not reflected in the downlink measurement reports at the eNB. As a result, unilateral action on the part of the UE (e.g., moving the uplink signal to a different channel) may be thwarted by the eNB, which is not aware of the uplink coexistence issue and seeks to undo the unilateral action. For instance, even if the UE re-establishes the connection on a different frequency channel, the network can still handover the UE back to the original frequency channel that was corrupted by the in-device interference. This is a likely scenario because the desired signal strength on the corrupted channel may sometimes be higher than reflected in the measurement reports of the new channel based on Reference Signal Received Power (RSRP) to the eNB. Hence, a ping-pong effect of being transferred back and forth between the corrupted channel and the desired channel can happen if the eNB uses RSRP reports to make handover decisions.

Other unilateral action on the part of the UE, such as simply stopping uplink communications without coordination of the eNB may cause power loop malfunctions at the eNB. Additional issues that exist in conventional LTE include a general lack of ability on the part of the UE to suggest desired configurations as an alternative to configurations that have coexistence issues. For at least these reasons, uplink coexistence issues at the UE may remain unresolved for a long time period, degrading performance and efficiency for other radios of the UE.

### SUMMARY

In accordance with an aspect of the present disclosure, a method for wireless communications for a multi-radio device is provided. The method includes analyzing an event combination of a first radio access technology (RAT) event and a second RAT event. The method also includes determining a desired power backoff to improve performance of the event combination. The method further includes recognizing an occurrence of the event combination. The method still further includes selectively applying the desired power backoff to the event combination.

According to another aspect, apparatus for wireless communications is provided. The apparatus includes means for analyzing an event combination of a first radio access technology (RAT) event and a second RAT event. The apparatus also includes means for determining a desired power backoff to improve performance of the event combination. The apparatus further includes means for recognizing an occurrence of the event combination. The apparatus still further includes means for selectively applying the desired power backoff to the event combination.

According to yet another aspect, a computer program product for wireless communications is provided. The computer program product includes a non-transitory computer-readable medium having program code recorded thereon. The program code includes program code to analyze an event combination of a first radio access technology (RAT) event and a second RAT event. The program code also includes program code to determine a desired power backoff to improve performance of the event combination. The program code further includes program code to recognize an occurrence of the event combination. The program code still further includes program code to selectively apply the desired power backoff to the event combination.

According to still yet another aspect, an apparatus for wireless communications is presented. The apparatus includes a memory and a processor(s) coupled to the memory. The processor(s) is configured to analyze an event combination of a first radio access technology (RAT) event and a second RAT event. The processor(s) is also configured to determine a desired power backoff to improve performance of the event combination. The processor(s) is further configured to recognize an occurrence of the event combination. The processor(s) is still further configured to selectively apply the desired power backoff to the event combination

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a multiple access wireless communication system according to one aspect.

FIG. 2 is a block diagram of a communication system according to one aspect.

FIG. 3 illustrates an exemplary frame structure in downlink Long Term Evolution (LTE) communications.

FIG. 4 is a block diagram conceptually illustrating an exemplary frame structure in uplink Long Term Evolution (LTE) communications.

FIG. 5 illustrates an example wireless communication environment.

FIG. 6 is a block diagram of an example design for a multi-radio wireless device.

FIG. 7 is graph showing respective potential collisions between seven example radios in a given decision period.

FIG. 8 is a diagram showing operation of an example Coexistence Manager (CxM) over time.

FIG. 9 is a block diagram illustrating adjacent frequency bands.

FIG. 10 is a block diagram of a system for providing support within a wireless communication environment for multi-radio coexistence management according to one aspect of the present disclosure.

FIG. 11 illustrates an example of a wireless communication frame structure according to certain aspects of the disclosure.

FIG. 12 illustrates example components capable of implementing techniques presented herein.

FIGS. 13-14 illustrate examples of coexistence management according to certain aspects of the disclosure.

FIG. 15 is a block diagram illustrating a coexistence management scheme according to aspects of the present disclosure.

FIG. 16 is a diagram illustrating an example of a hardware implementation for an apparatus employing a coexistence management scheme.

### DETAILED DESCRIPTION

Various aspects of the disclosure provide techniques to mitigate interference on a multi-radio device by adjusting operation of multiple radio access technologies (RATs) based on communication event combinations.

The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network can implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in portions of the description below.

Single carrier frequency division multiple access (SC-FDMA), which utilizes single carrier modulation and frequency domain equalization is a technique that can be utilized with various aspects described herein. SC-FDMA has similar performance and essentially the same overall complexity as those of an OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for an uplink multiple access scheme in 3GPP Long Term Evolution (LTE), or Evolved UTRA.

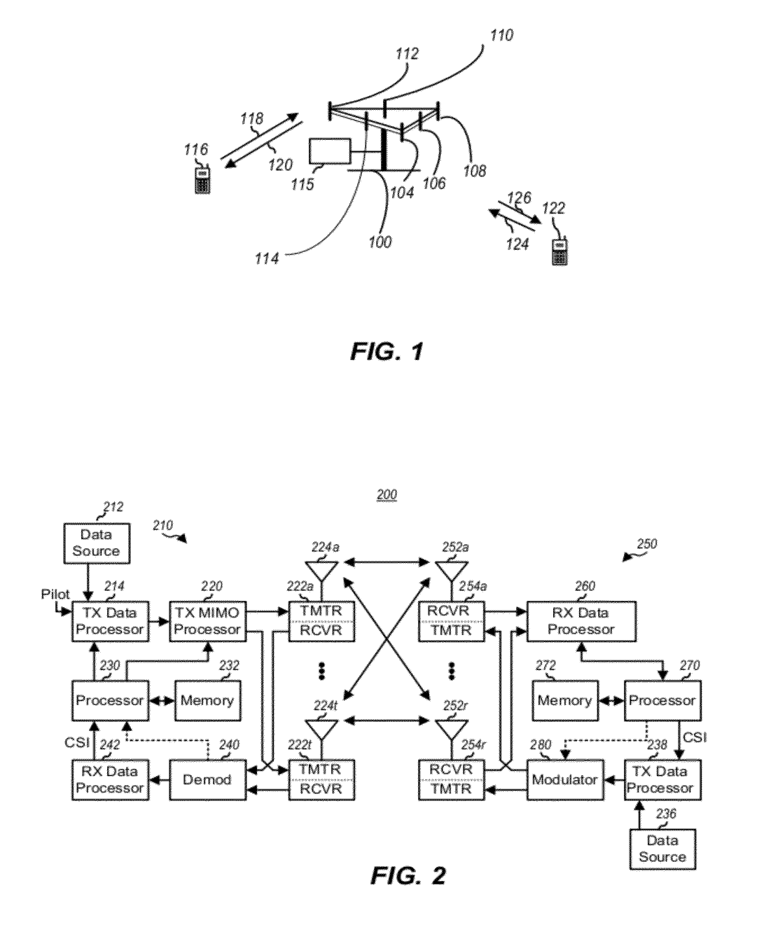

Referring to FIG. 1, a multiple access wireless communication system according to one aspect is illustrated. An evolved Node B 100 (eNB) includes a computer 115 that has processing resources and memory resources to manage the LTE communications by allocating resources and parameters, granting/denying requests from user equipment, and/or the like. The eNB 100 also has multiple antenna groups, one group including antenna 104 and antenna 106, another group including antenna 108 and antenna 110, and an additional group including antenna 112 and antenna 114. In FIG. 1, only two antennas are shown for each antenna group, however, more or fewer antennas can be utilized for each antenna group. A User Equipment (UE) 116 (also referred to as an Access Terminal (AT)) is in communication with antennas 112 and 114, while antennas 112 and 114 transmit information to the UE 116 over an uplink (UL) 188. The UE 122 is in communication with antennas 106 and 108, while antennas 106 and 108 transmit information to the UE 122 over a downlink (DL) 126 and receive information from the UE 122 over an uplink 124. In a frequency division duplex (FDD) system, communication links 118, 120, 124 and 126 can use different frequencies for communication. For example, the downlink 120 can use a different frequency than used by the uplink 118.

Each group of antennas and/or the area in which they are designed to communicate is often referred to as a sector of the eNB. In this aspect, respective antenna groups are designed to communicate to UEs in a sector of the areas covered by the eNB 100.

In communication over the downlinks 120 and 126, the transmitting antennas of the eNB 100 utilize beamforming to improve the signal-to-noise ratio of the uplinks for the different UEs 116 and 122. Also, an eNB using beamforming to transmit to UEs scattered randomly through its coverage causes less interference to UEs in neighboring cells than a UE transmitting through a single antenna to all its UEs.

An eNB can be a fixed station used for communicating with the terminals and can also be referred to as an access point, base station, or some other terminology. A UE can also be called an access terminal, a wireless communication device, terminal, or some other terminology.

FIG. 2 is a block diagram of an aspect of a transmitter system 210 (also known as an eNB) and a receiver system 250 (also known as a UE) in a MIMO system 200. In some instances, both a UE and an eNB each have a transceiver that includes a transmitter system and a receiver system. At the transmitter system 210, traffic data for a number of data streams is provided from a data source 212 to a transmit (TX) data processor 214.

A MIMO system employs multiple (N_{T}) transmit antennas and multiple (N_{R}) receive antennas for data transmission. A MIMO channel formed by the N_{T} transmit and N_{R} receive antennas may be decomposed into Nₛ independent channels, which are also referred to as spatial channels, wherein N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) and frequency division duplex (FDD) systems. In a TDD system, the uplink and downlink transmissions are on the same frequency region so that the reciprocity principle allows the estimation of the downlink channel from the uplink channel. This enables the eNB to extract transmit beamforming gain on the downlink when multiple antennas are available at the eNB.

In an aspect, each data stream is transmitted over a respective transmit antenna. The TX data processor 214 formats, codes, and interleaves the traffic data for each data stream based on a particular coding scheme selected for that data stream to provide coded data.

The coded data for each data stream can be multiplexed with pilot data using OFDM techniques. The pilot data is a known data pattern processed in a known manner and can be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream can be determined by instructions performed by a processor 230 operating with a memory 232.

The modulation symbols for respective data streams are then provided to a TX MIMO processor 220, which can further process the modulation symbols (e.g., for OFDM). The TX MIMO processor 220 then provides N_{T} modulation symbol streams to N_{T} transmitters (TMTR) 222a through 222t. In certain aspects, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from the transmitters 222a through 222t are then transmitted from N_{T} antennas 224a through 224t, respectively.

At a receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{R} “detected” symbol streams. The RX data processor 260 then demodulates, deinterleaves, and decodes each detected symbol stream to recover the traffic data for the data stream. The processing by the RX data processor 260 is complementary to the processing performed by the TX MIMO processor 220 and the TX data processor 214 at the transmitter system 210.

A processor 270 (operating with a memory 272) periodically determines which pre-coding matrix to use (discussed below). The processor 270 formulates an uplink message having a matrix index portion and a rank value portion.

The uplink message can include various types of information regarding the communication link and/or the received data stream. The uplink message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by antennas 224, conditioned by receivers 222, demodulated by a demodulator 240, and processed by an RX data processor 242 to extract the uplink message transmitted by the receiver system 250. The processor 230 then determines which pre-coding matrix to use for determining the beamforming weights, then processes the extracted message.

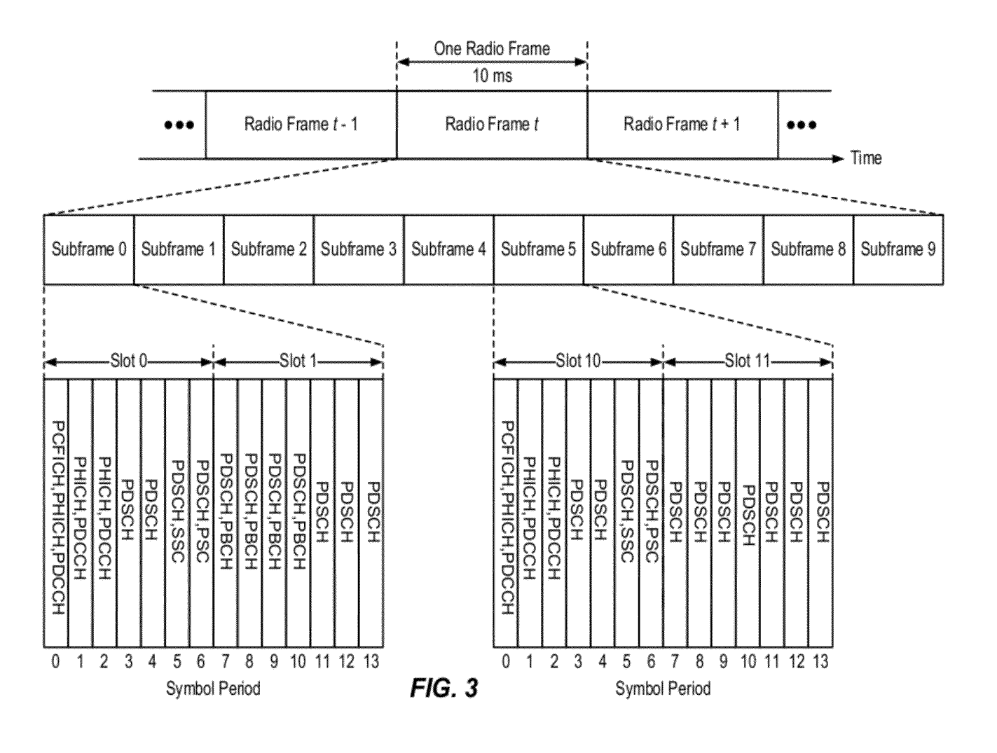

FIG. 3 is a block diagram conceptually illustrating an exemplary frame structure in downlink Long Term Evolution (LTE) communications. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 3) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a Primary Synchronization Signal (PSS) and a Secondary Synchronization Signal (SSS) for each cell in the eNB. The PSS and SSS may be sent in symbol periods 6 and 5, respectively, in each of subframes 0 and 5 of each radio frame with the normal cyclic prefix, as shown in FIG. 3. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Cell-specific Reference Signal (CRS) for each cell in the eNB. The CRS may be sent in symbols 0, 1, and 4 of each slot in case of the normal cyclic prefix, and in symbols 0, 1, and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNB may send a Physical Control Format Indicator Channel (PCFICH) in the first symbol period of each subframe, as seen in FIG. 3. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 3, M=3. The eNB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 3. The PHICH may carry information to support Hybrid Automatic Repeat Request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

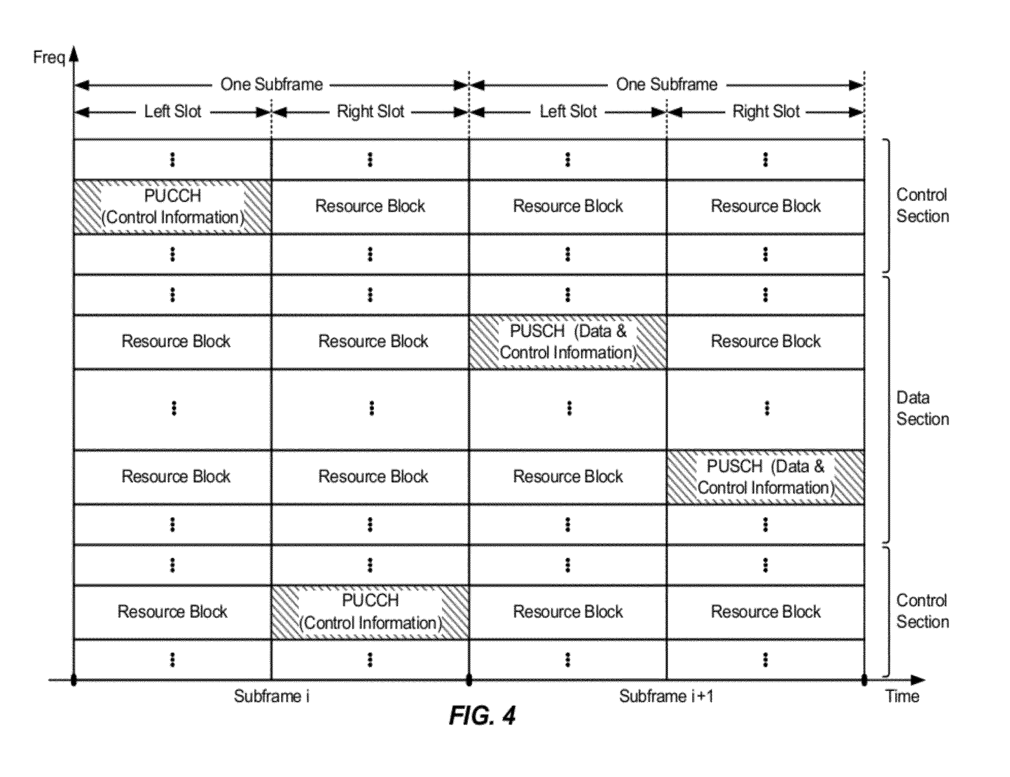

FIG. 4 is a block diagram conceptually illustrating an exemplary frame structure in uplink Long Term Evolution (LTE) communications. The available Resource Blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 4 results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNodeB. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in FIG. 4.

The PSS, SSS, CRS, PBCH, PUCCH and PUSCH in LTE are described in 3GPP TS 36.211, entitled “Evolved Universal Terrestrial Radio Access (E-UTRA); Physical Channels and Modulation,” which is publicly available.

In an aspect, described herein are systems and methods for providing support within a wireless communication environment, such as a 3GPP LTE environment or the like, to facilitate multi-radio coexistence solutions.

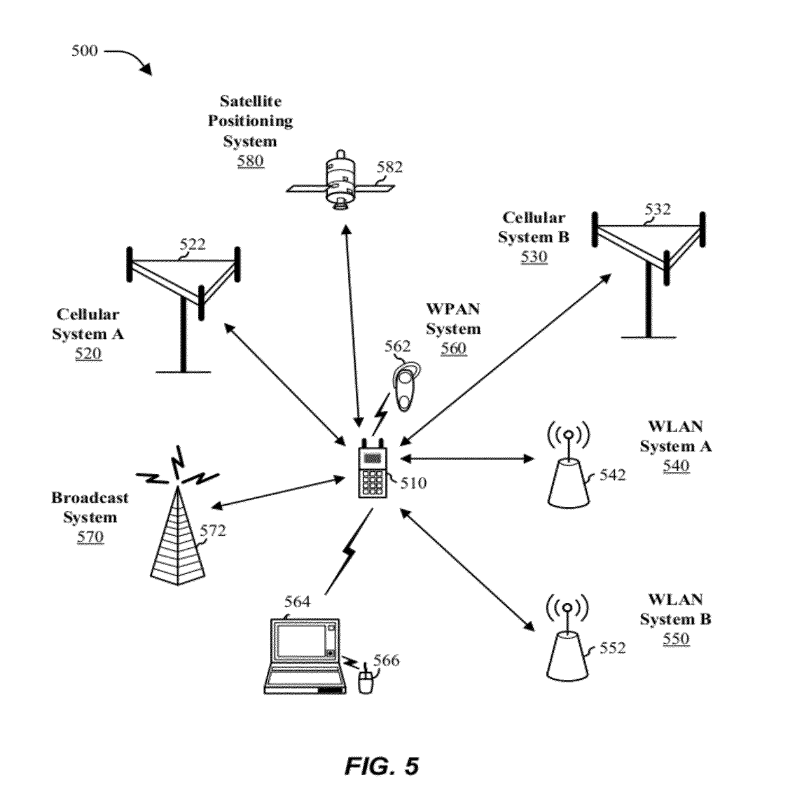

Referring now to FIG. 5, illustrated is an example wireless communication environment 500 in which various aspects described herein can function. The wireless communication environment 500 can include a wireless device 510, which can be capable of communicating with multiple communication systems. These systems can include, for example, one or more cellular systems 520 and/or 530, one or more WLAN systems 540 and/or 550, one or more wireless personal area network (WPAN) systems 560, one or more broadcast systems 570, one or more satellite positioning systems 580, other systems not shown in FIG. 5, or any combination thereof. It should be appreciated that in the following description the terms “network” and “system” are often used interchangeably.

The cellular systems 520 and 530 can each be a CDMA, TDMA, FDMA, OFDMA, Single Carrier FDMA (SC-FDMA), or other suitable system. A CDMA system can implement a radio technology such as Universal Terrestrial Radio Access (UTRA), cdma2000, etc. UTRA includes Wideband CDMA (WCDMA) and other variants of CDMA. Moreover, cdma2000 covers IS-2000 (CDMA2000 1X), IS-95 and IS-856 (HRPD) standards. A TDMA system can implement a radio technology such as Global System for Mobile Communications (GSM), Digital Advanced Mobile Phone System (D-AMPS), etc. An OFDMA system can implement a radio technology such as Evolved UTRA (E-UTRA), Ultra Mobile Broadband (UMB), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3^{rd} Generation Partnership Project” (3GPP). cdma2000 and UMB are described in documents from an organization named “3^{rd} Generation Partnership Project 2” (3GPP2). In an aspect, the cellular system 520 can include a number of base stations 522, which can support bi-directional communication for wireless devices within their coverage. Similarly, the cellular system 530 can include a number of base stations 532 that can support bi-directional communication for wireless devices within their coverage.

WLAN systems 540 and 550 can respectively implement radio technologies such as IEEE 802.11 (WiFi), Hiperlan, etc. The WLAN system 540 can include one or more access points 542 that can support bi-directional communication. Similarly, the WLAN system 550 can include one or more access points 552 that can support bi-directional communication. The WPAN system 560 can implement a radio technology such as Bluetooth (BT), IEEE 802.15, etc. Further, the WPAN system 560 can support bi-directional communication for various devices such as wireless device 510, a headset 562, a computer 564, a mouse 566, or the like.

The broadcast system 570 can be a television (TV) broadcast system, a frequency modulation (FM) broadcast system, a digital broadcast system, etc. A digital broadcast system can implement a radio technology such as MediaFLO™, Digital Video Broadcasting for Handhelds (DVB-H), Integrated Services Digital Broadcasting for Terrestrial Television Broadcasting (ISDB-T), or the like. Further, the broadcast system 570 can include one or more broadcast stations 572 that can support one-way communication.

The satellite positioning system 580 can be the United States Global Positioning System (GPS), the European Galileo system, the Russian GLONASS system, the Quasi-Zenith Satellite System (QZSS) over Japan, the Indian Regional Navigational Satellite System (IRNSS) over India, the Beidou system over China, and/or any other suitable system. Further, the satellite positioning system 580 can include a number of satellites 582 that transmit signals for position determination.

In an aspect, the wireless device 510 can be stationary or mobile and can also be referred to as a user equipment (UE), a mobile station, a mobile equipment, a terminal, an access terminal, a subscriber unit, a station, etc. The wireless device 510 can be cellular phone, a personal digital assistance (PDA), a wireless modem, a handheld device, a laptop computer, a cordless phone, a wireless local loop (WLL) station, etc. In addition, a wireless device 510 can engage in two-way communication with the cellular system 520 and/or 530, the WLAN system 540 and/or 550, devices with the WPAN system 560, and/or any other suitable systems(s) and/or devices(s). The wireless device 510 can additionally or alternatively receive signals from the broadcast system 570 and/or satellite positioning system 580. In general, it can be appreciated that the wireless device 510 can communicate with any number of systems at any given moment. Also, the wireless device 510 may experience coexistence issues among various ones of its constituent radio devices that operate at the same time. Accordingly, the wireless device 510 includes a coexistence manager (CxM, not shown) that has a functional module to detect and mitigate coexistence issues, as explained further below.

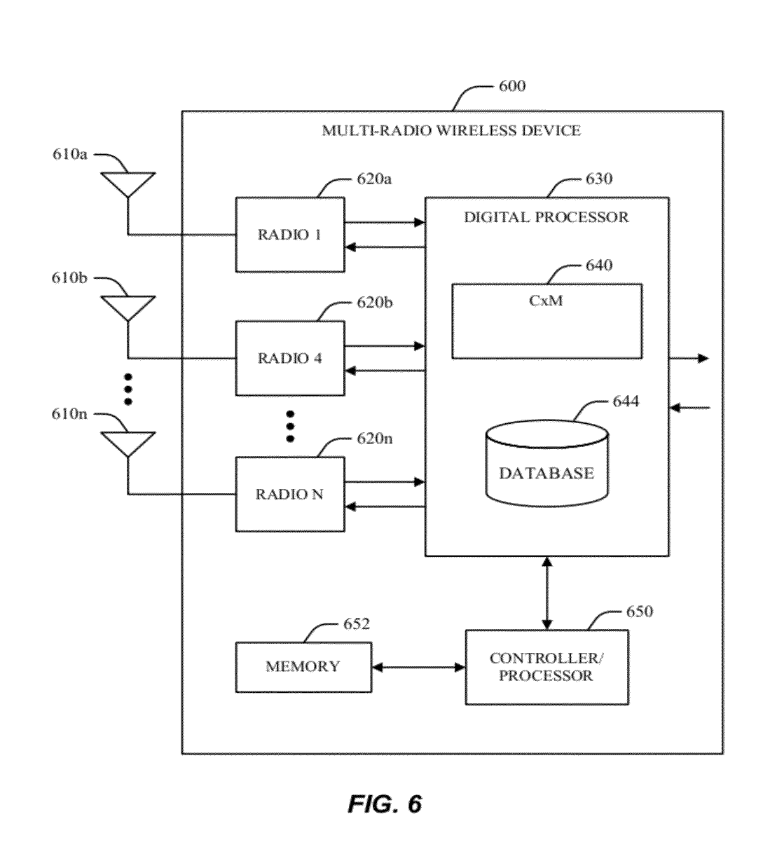

Turning next to FIG. 6, a block diagram is provided that illustrates an example design for a multi-radio wireless device 600 and may be used as an implementation of the wireless device 510 of FIG. 5. As FIG. 6 illustrates, the wireless device 600 can include N radios 620a through 620n, which can be coupled to N antennas 610a through 610n, respectively, where N can be any integer value. It should be appreciated, however, that respective radios 620 can be coupled to any number of antennas 610 and that multiple radios 620 can also share a given antenna 610.

In general, a radio 620 can be a unit that radiates or emits energy in an electromagnetic spectrum, receives energy in an electromagnetic spectrum, or generates energy that propagates via conductive means. By way of example, a radio 620 can be a unit that transmits a signal to a system or a device or a unit that receives signals from a system or device. Accordingly, it can be appreciated that a radio 620 can be utilized to support wireless communication. In another example, a radio 620 can also be a unit (e.g., a screen on a computer, a circuit board, etc.) that emits noise, which can impact the performance of other radios. Accordingly, it can be further appreciated that a radio 620 can also be a unit that emits noise and interference without supporting wireless communication.

In an aspect, respective radios 620 can support communication with one or more systems. Multiple radios 620 can additionally or alternatively be used for a given system, e.g., to transmit or receive on different frequency bands (e.g., cellular and PCS bands).

In another aspect, a digital processor 630 can be coupled to radios 620a through 620n and can perform various functions, such as processing for data being transmitted or received via the radios 620. The processing for each radio 620 can be dependent on the radio technology supported by that radio and can include encryption, encoding, modulation, etc., for a transmitter; demodulation, decoding, decryption, etc., for a receiver, or the like. In one example, the digital processor 630 can include a coexistence manager (CxM) 640 that can control operation of the radios 620 in order to improve the performance of the wireless device 600 as generally described herein. The CxM 640 can have access to a database 644, which can store information to control the operation of the radios 620. As explained further below, the CxM 640 can be adapted for a variety of techniques to decrease interference between the radios. In one example, the CxM 640 requests a measurement gap pattern or DRX cycle that allows an ISM radio to communicate during periods of LTE inactivity.

For simplicity, digital processor 630 is shown in FIG. 6 as a single processor. However, it should be appreciated that the digital processor 630 can include any number of processors, controllers, memories, etc. In one example, a controller/processor 650 can direct the operation of various units within the wireless device 600. Additionally or alternatively, a memory 652 can store program codes and data for the wireless device 600. The digital processor 630, controller/processor 650, and memory 652 can be implemented on one or more integrated circuits (ICs), application specific integrated circuits (ASICs), etc. By way of specific, non-limiting example, the digital processor 630 can be implemented on a Mobile Station Modem (MSM) ASIC.

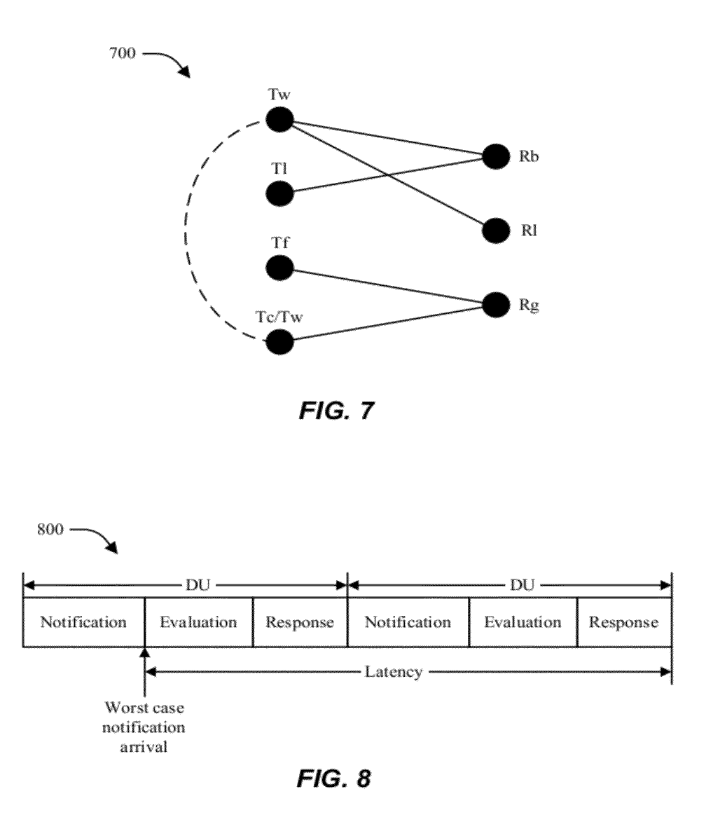

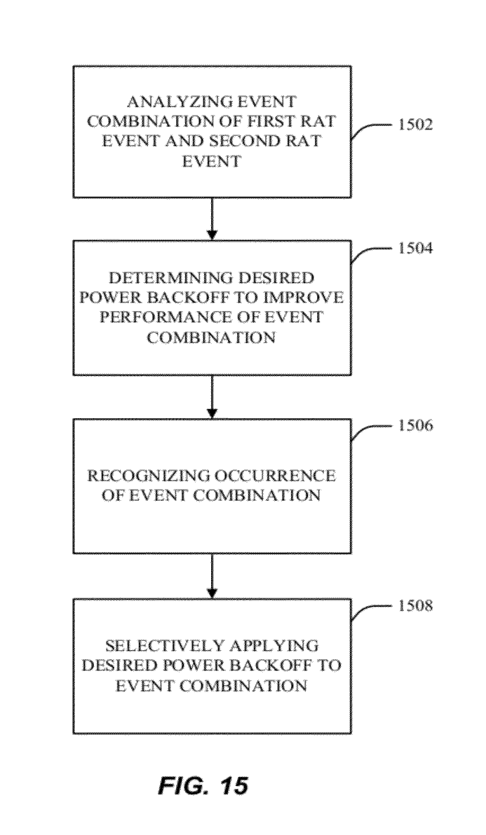

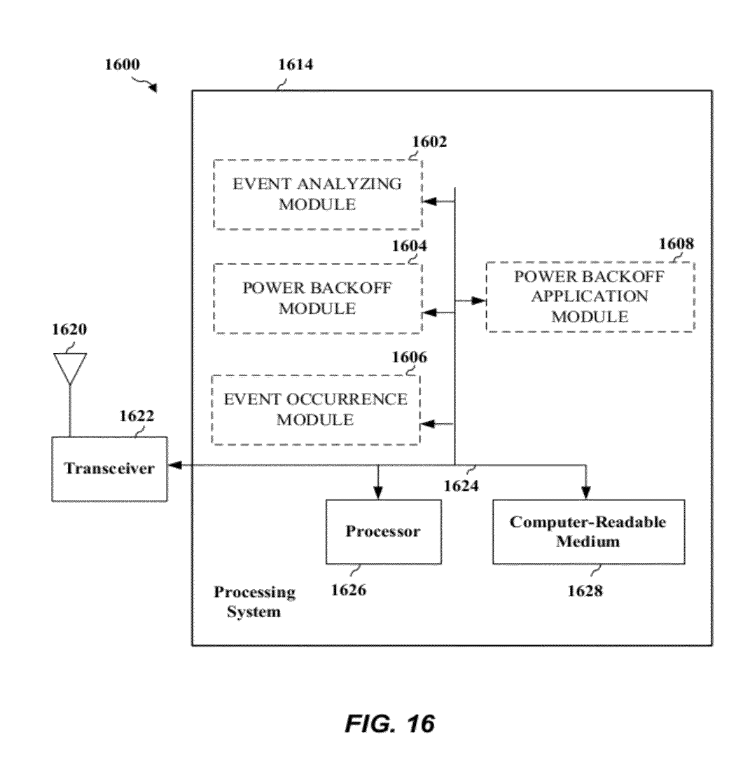

In an aspect, the CxM 640 can manage operation of respective radios 620 utilized by wireless device 600 in order to avoid interference and/or other performance degradation associated with collisions between respective radios 620. The CxM 640 may perform one or more processes, such as those illustrated in FIGS. 15-16. By way of further illustration, a graph 700 in FIG. 7 represents respective potential collisions between seven example radios in a given decision period. In the example shown in graph 700, the seven radios include a WLAN transmitter (Tw), an LTE transmitter (Tl), an FM transmitter (Tf), a GSM/WCDMA transmitter (Tc/Tw), an LTE receiver (Rl), a Bluetooth receiver (Rb), and a GPS receiver (Rg). The four transmitters are represented by four nodes on the left side of the graph 700. The four receivers are represented by three nodes on the right side of the graph 700.

A potential collision between a transmitter and a receiver is represented on the graph 700 by a branch connecting the node for the transmitter and the node for the receiver. Accordingly, in the example shown in the graph 700, collisions may exist between (1) the WLAN transmitter (Tw) and the Bluetooth receiver (Rb); (2) the LTE transmitter (Tl) and the Bluetooth receiver (Rb); (3) the WLAN transmitter (Tw) and the LTE receiver (Rl); (4) the FM transmitter (Tf) and the GPS receiver (Rg); (5) a WLAN transmitter (Tw), a GSM/WCDMA transmitter (Tc/Tw), and a GPS receiver (Rg).

In one aspect, an example CxM 640 can operate in time in a manner such as that shown by diagram 800 in FIG. 8. As diagram 800 illustrates, a timeline for coexistence manager operation can be divided into Decision Units (DUs), which can be any suitable uniform or non-uniform length (e.g., 100 μs) where notifications are processed, and a response phase (e.g., 20 μs) where commands are provided to various radios 620 and/or other operations are performed based on actions taken in the evaluation phase. In one example, the timeline shown in the diagram 800 can have a latency parameter defined by a worst case operation of the timeline, e.g., the timing of a response in the case that a notification is obtained from a given radio immediately following termination of the notification phase in a given DU.

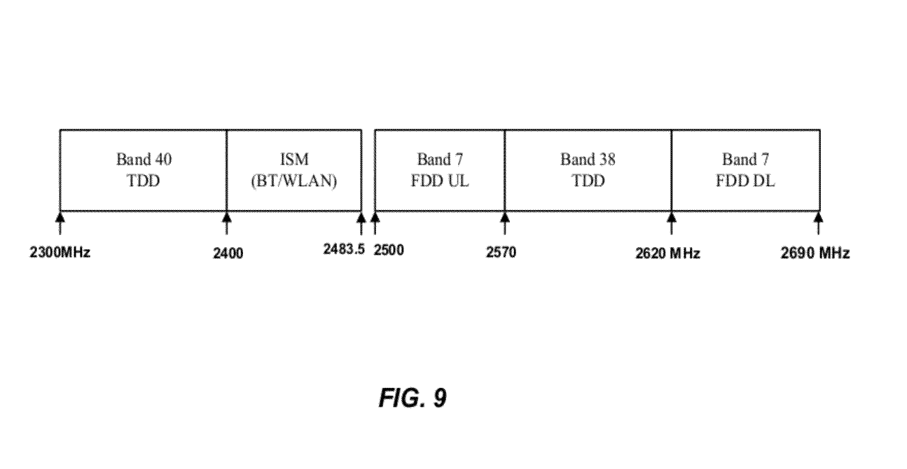

As shown in FIG. 9, Long Term Evolution (LTE) in band 7 (for frequency division duplex (FDD) uplink), band 40 (for time division duplex (TDD) communication), and band 38 (for TDD downlink) is adjacent to the 2.4 GHz Industrial Scientific and Medical (ISM) band used by Bluetooth (BT) and Wireless Local Area Network (WLAN) technologies. Frequency planning for these bands is such that there is limited or no guard band permitting traditional filtering solutions to avoid interference at adjacent frequencies. For example, a 20 MHz guard band exists between ISM and band 7, but no guard band exists between ISM and band 40.

To be compliant with appropriate standards, communication devices operating over a particular band are to be operable over the entire specified frequency range. For example, in order to be LTE compliant, a mobile station/user equipment should be able to communicate across the entirety of both band 40 (2300-2400 MHz) and band 7 (2500-2570 MHz) as defined by the 3rd Generation Partnership Project (3GPP). Without a sufficient guard band, devices employ filters that overlap into other bands causing band interference. Because band 40 filters are 100 MHz wide to cover the entire band, the rollover from those filters crosses over into the ISM band causing interference. Similarly, ISM devices that use the entirety of the ISM band (e.g., from 2401 through approximately 2480 MHz) will employ filters that rollover into the neighboring band 40 and band 7 and may cause interference.

In-device coexistence problems can exist with respect to a UE between resources such as, for example, LTE and ISM bands (e.g., for Bluetooth/WLAN). In current LTE implementations, any interference issues to LTE are reflected in the downlink measurements (e.g., Reference Signal Received Quality (RSRQ) metrics, etc.) reported by a UE and/or the downlink error rate which the eNB can use to make inter-frequency or inter-RAT handoff decisions to, e.g., move LTE to a channel or RAT with no coexistence issues. However, it can be appreciated that these existing techniques will not work if, for example, the LTE uplink is causing interference to Bluetooth/WLAN but the LTE downlink does not see any interference from Bluetooth/WLAN. More particularly, even if the UE autonomously moves itself to another channel on the uplink, the eNB can in some cases handover the UE back to the problematic channel for load balancing purposes. In any case, it can be appreciated that existing techniques do not facilitate use of the bandwidth of the problematic channel in the most efficient way.

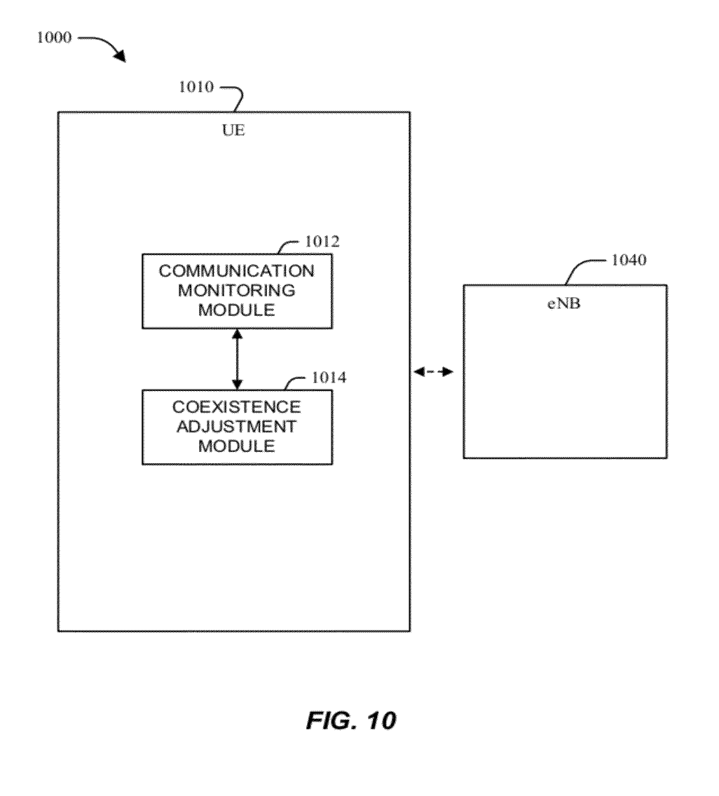

Turning now to FIG. 10, a block diagram of a system 1000 for providing support within a wireless communication environment for multi-radio coexistence management is illustrated. In an aspect, the system 1000 can include one or more UEs 1010 and/or eNBs 1040, which can engage in uplink and/or downlink communications, and/or any other suitable communication with each other and/or any other entities in the system 1000. In one example, the UE 1010 and/or eNB 1040 can be operable to communicate using a variety resources, including frequency channels and sub-bands, some of which can potentially be colliding with other radio resources (e.g., a broadband radio such as an LTE modem). Thus, the UE 1010 can utilize various techniques for managing coexistence between multiple radios utilized by the UE 1010, as generally described herein.

To mitigate at least the above shortcomings, the UE 1010 can utilize respective features described herein and illustrated by the system 1000 to facilitate support for multi-radio coexistence within the UE 1010. For example, a communication monitoring module 1012 and a coexistence adjustment module 1014 can be provided. The various modules 1012-1014 may, in some examples, be implemented as part of a coexistence manager such as the CxM 640 of FIG. 6. The various modules 1012-1014 and others may be configured to implement the embodiments discussed herein.

### Coexistence Management Scheme for Multi-Radio Co-Existence

Offered is a power adjustment scheme for mitigating potential interference while enabling satisfactory performance from multiple radio access technologies (RATs) in a single device. A coexistence manager (CxM) may determine potential communication event combinations which include information about overlapping communication events of various RATs of the mobile device. Based at least in part on potential cross-RAT interference of the event combinations, the coexistence manager may execute a coexistence management scheme for the particular combinations at the time they occur. A table of communication event combinations and corresponding coexistence management schemes may be predetermined to reduce interference in view of the various combinations.

Coexistence management schemes may adjust a transmission power for a second RAT based on whether the transmission of the second RAT occurs during a transmission or reception time period of the first RAT. Furthermore, the coexistence manager may also adjust the transmission power for the second RAT according to the channel frequencies of the first RAT and the second RAT. For example, the coexistence manager may adjust a transmission power for Bluetooth (BT) transmissions to mitigate an impact on LTE reception.

In a typical UE, the adjustment for the transmission power for the second RAT in a multi-radio UE may be static. That is, the transmission power may be adjusted (e.g., backed off) based on an average level of interference experienced by a first RAT, the interference being caused by the second RAT. Accordingly, in a static adjustment of the transmission power, the full transmission power levels of the second RAT may not be utilized for instances when the second RAT may transmit at higher levels without causing interference (e.g., when a first RAT and a second RAT are transmitting concurrently). Thus, it is desirable to dynamically adjust the transmission power for the second RAT. Specifically, the adjustment of the transmission power may depend on the timing of the transmission/reception activity of the individual RATs. According to certain aspects, a coexistence manager may reduce the transmission power for the second RAT if its transmissions occur when the first RAT is receiving a signal. Conversely, the coexistence manager may increase transmissions power for the second RAT if the transmissions occur when the first RAT is transmitting a signal.

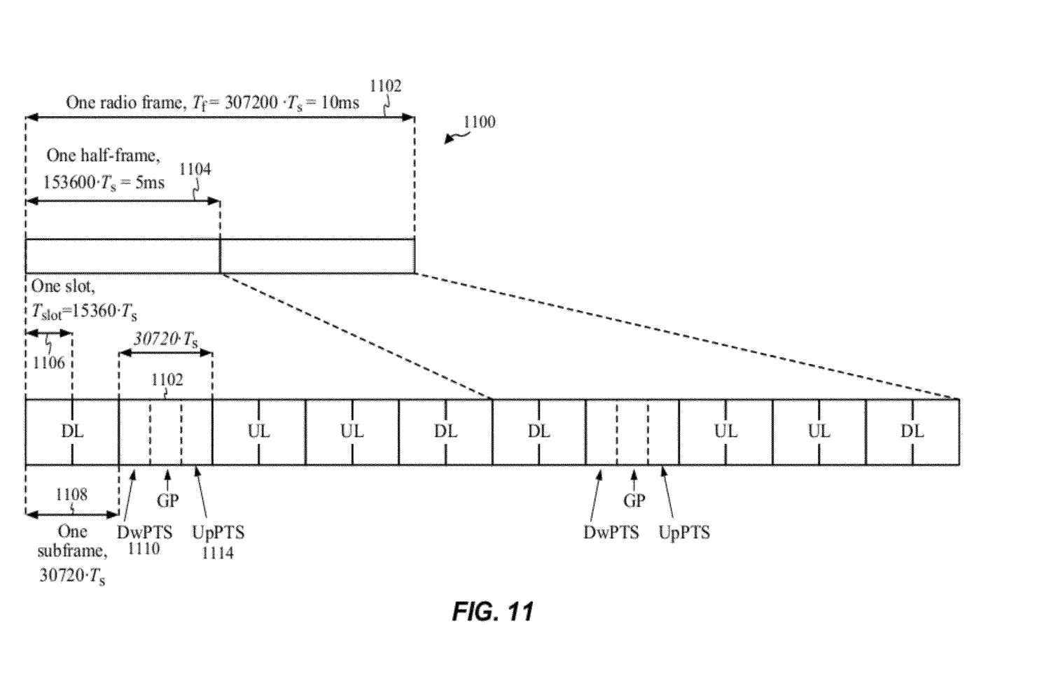

In a typical Time Division Duplex (TDD) device, the communications utilize a variety of transmission and reception patterns depending on the particular TDD modes and configurations of the respective RATs. FIG. 11 illustrates an example structure 1100 of a communication frame in TDD mode according to the LTE-TDD standard. As illustrated, each 10 ms radio frame 1102 is divided into two 5 ms half frames 1104. Each half frame consists of 10 subframes 1108. An LTE-TDD frame includes a special sub-frame (S) containing three parts: downlink pilot time slot (DwPTS) 1110, guard period (GP) 1112, and uplink pilot time slot (UpPTS) 1114. The guard period (GP) counters the propagation delay of the inter-site distance so as to avoid base station to base station interference when switching between downlink and uplink transmissions. The fields DwPTS, GP and UpPTS may span, for example, 3˜12, 1˜10 and 1˜2 OFDM symbols, respectively. The remaining subframes may be designated for uplink (UL) and downlink (DL) transmissions (i.e., transmission and reception relative to a UE.)

As noted above, LTE may utilize a LTE-TDD configuration with a particular pattern for transmission and reception. For example, in TDD configuration 1, LTE may utilize a 5 ms half radio frame periodicity, as shown, and within each half radio frame, a duration of time comprising 2 ms may be available for downlink transmissions, 2 ms of time may be utilized for uplink transmissions, and the remaining 1 ms is reserved for a special sub-frame.

Typically, Bluetooth is a packet-based protocol that exchanges packets between connected devices based on a clock, defined by one of the connected devices (the “master” device), that ticks at 312.5 μs intervals. Two clock ticks comprise a slot having a duration of 625 μs, and two slots make up a slot pair. In some cases, the master device transmits in even slots and receives in odd slots, while a connected “slave” devices receives in even slots and transmits in odd slots. thus, according to certain aspects, particular time intervals corresponding with Bluetooth transmission may align with time intervals for a LTE transmission/reception, depending on the periodicity and configuration of the LTE communications.

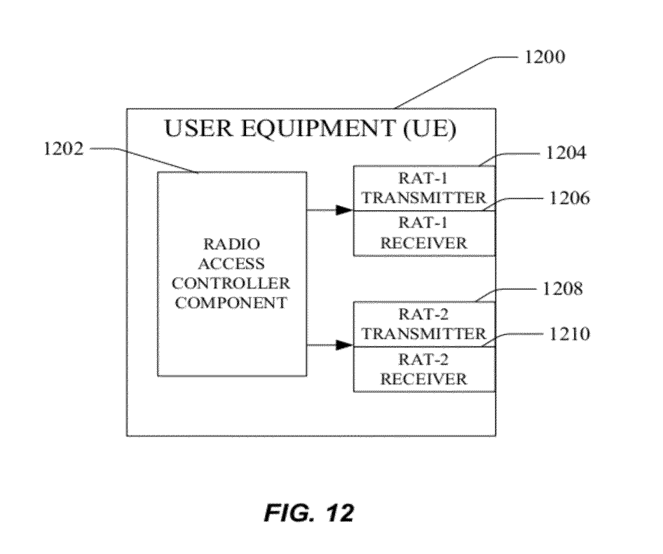

FIG. 12 illustrates an example user equipment 1200 capable of managing multi-radio transmissions according to the aspects of the present disclosure. According to certain aspects, the user equipment 1200 may be configured to support a plurality of RATs. As illustrated, the user equipment 1200 includes a first transmitter 1204 and receiver 1206 configured to utilize a first RAT, and a second transmitter 1208 and receiver 1210 configured to utilize a second RAT. According to certain aspects, the first RAT may be an LTE radio, and the second RAT may be a Bluetooth radio.

The user equipment 1200 further includes a radio access controller component 1202 configured to adjust transmission power of the first transmitter 1204 and a second transmitter 1208 according to aspects of the present disclosure. The radio access controller component 1202 may be the coexistence manager 640. According to certain aspects, the radio access controller component 1202 may determine transmission time instances and configurations for the first and/or second RAT (e.g., periods when transmission is allowed and various settings for those transmissions) and may determine reception time instances and configurations (e.g., periods when reception is allowed and various settings for those receptions). According to certain aspects, for a particular time interval, the radio access controller component 1202 may utilize the determined transmission and reception time instances to configure a transmission power for the first and/or second RAT.

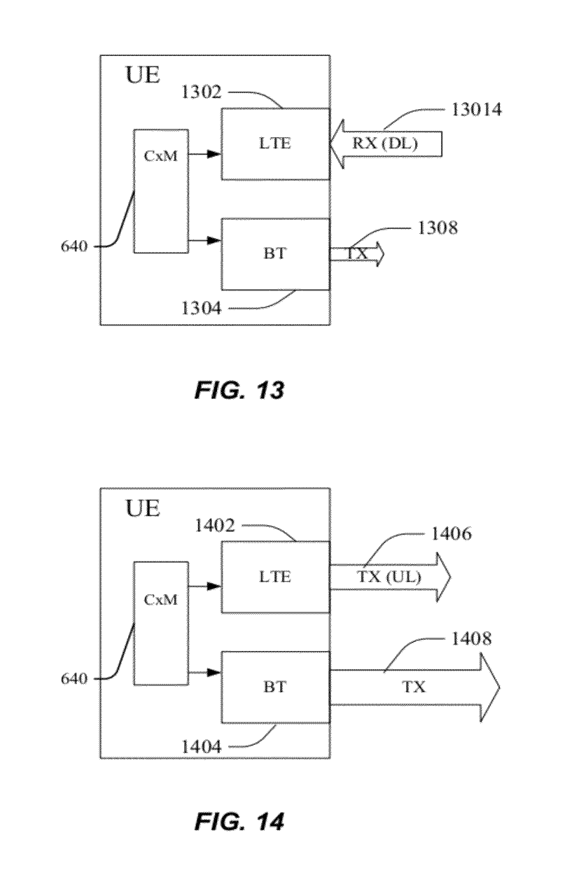

FIGS. 13-14 illustrate example operations that may be performed by a wireless device such as the user equipment 1200 of FIG. 12. As illustrated in FIG. 13, a LTE radio 1302 may receive a LTE downlink transmission 1306 concurrently with a Bluetooth radio 1304 transmitting a Bluetooth transmission 1308. According to an aspect of the present disclosure, the coexistence manager 640 may reduce the transmission power of the Bluetooth transmission 1308 to a value that reduces an impact to the LTE downlink transmission 1306. That is, a Bluetooth transmission power may be backed off to a value that reduces an impact to LTE communications when the Bluetooth transmission falls within, or partially falls within, a time period designated for the LTE downlink transmission.

According to certain aspects, the Bluetooth transmission power may be reduced to a predetermined backoff value selected to reduce interference with the downlink transmission 1306. According to certain aspects, the Bluetooth transmission power may be dynamically reduced based on a feedback loop focused on LTE performance. For example, the Bluetooth transmission power may be reduced at a pre-determined rate until the coexistence manager 640 determines the satisfactory performance on the LTE radio 1302.

Furthermore, according to certain aspects, the Bluetooth transmission power may be lower bounded to ensure a desired performance for Bluetooth. The backed-off Bluetooth transmission may be restricted to a threshold transmission power such that the Bluetooth radio may still perform at a satisfactory level. A variety of metrics may be used to measure performance, such as, for example, packet error rate (PER), slot error rate (SLER), and/or received signal strength indication (RSSI).

As illustrated in FIG. 14, a Bluetooth transmission 1408 may be transmitted concurrently with an LTE uplink transmission 1406. The Bluetooth transmission 1408 may transmit at a high or maximum power when the Bluetooth transmission 1408 is configured to be transmitted during a time designated for uplink transmissions. The LTE radio 1402 and the Bluetooth radio 1404 may utilize high transmission power for their respective transmissions 1406 and 1408 because Bluetooth transmissions causes little to no impact on LTE transmissions when the uplinks occur concurrently. According to certain aspects, a power adjustment scheme as described herein may be employed during high duty cycle operations, such as paging or inquiry operations. According to certain aspects, devices connecting to the UE using a communications protocol such as Bluetooth are typically in close proximity and may not need maximum transmission power for successful communications.

According to certain aspects, the Bluetooth transmission power may be adjusted according to whether the Bluetooth transmission occurs during a LTE uplink or downlink, the channel frequency of the Bluetooth transmission, the channel frequency of the LTE transmission/reception, and other communication conditions. Taking into consideration these communication factors may allow a coexistence manager to determine a coexistence plan for various overlapping communication instances of the multiple RATs. The coexistence plan may then be executed depending on the communication conditions of the multiple RATs at a particular point in time. For example, if the channel frequencies utilized by the different RATs are proximate to each other, a different coexistence management scheme may be employed than when the channel frequencies utilized by the different RATs are farther apart. While the example of a two RAT mobile device is used, the aspects herein may be applied for devices with more than two RATs as well.

A coexistence manager may prepare a record of potential communication scenarios of each RAT. For example, a table may be prepared where various combinations of communication event configurations of each RAT are considered, and a desired power backoff level/coexistence management scheme determined for those event combinations. For example, if the first RAT is transmitting and the second RAT is receiving, but the first RAT is operating at a high end of a frequency spectrum and the second RAT is operating at a low end of a frequency spectrum, a low or zero level of power backoff may be desired due to a low likelihood of interference due to the difference in operating frequencies. In another example, if the first RAT is transmitting and the second RAT is receiving and both are operating in a similar frequency range, then an increased power backoff may be desired. In another example, if the first RAT is transmitting in a first frequency range and the second RAT is receiving in a second frequency range that overlaps with a harmonic of the first frequency range, a certain power backoff may be desired. The desired level of power backoff may be adjusted and recalculated based on altering communication conditions experienced by the mobile device and the RAT radios.

The various combination of potentially overlapping communication instances of the first and second RAT may be referred to as a communication event combination. The coexistence manager may determine what actions to take when faced with a particular communication even combination so that when the combination appears, a particular coexistence management scheme (which may include power backoff) is ready to be implemented. As part of the coexistence management scheme the coexistence manager may analyze interference levels and other metrics (e.g., average packet error) to determine a desired power level for each RAT in the communication event combination according to which RATs are receiving, on what frequencies, and/or other communication conditions.

According to one aspect, the desired operation (including power levels, etc.) of each RAT may be predetermined based at least in part on potential communication event combinations prior to actual communications by the individual radios. According to one aspect, the coexistence management scheme may be altered as event combinations change or as otherwise configured by a coexistence manager. Alterations may occur dynamically, according to specific intervals, or when it is determined that an operating condition of the UE has changed.

As shown in FIG. 15 a UE may analyze an event combination of a first RAT event and a second RAT event, as shown in block 1502. A UE may determine a desired power backoff to improve performance of the event combination, as shown in block 1504. The UE may then recognize an occurrence of the event combination, as shown in block 1506. Finally, the UE may selectively apply the desired power backoff to the event combination, as shown in block 1508.

FIG. 16 is a diagram illustrating an example of a hardware implementation for a user equipment 1600 employing a power backoff system 1614. The power backoff system 1614 may be implemented with a bus architecture, represented generally by a bus 1624. The bus 1624 may include any number of interconnecting buses and bridges depending on the specific application of the power backoff system 1614 and the overall design constraints. The bus 1624 links together various circuits including one or more processors and/or hardware modules, represented by a processor 1626, an event analyzing module 1602, a power backoff module 1604, an event occurrence module 1606, a power backoff application module, and a computer-readable medium 1628. The bus 1624 may also link various other circuits such as timing sources, peripherals, voltage regulators, and power management circuits, which are well known in the art, and therefore, will not be described any further.

The apparatus includes the power backoff system 1614 coupled to a transceiver 1622. The transceiver 1622 is coupled to one or more antennas 1620. The transceiver 1622 provides a means for communicating with various other apparatus over a transmission medium. The power backoff system 1614 includes the processor 1626 coupled to the computer-readable medium 1628. The processor 1626 is responsible for general processing, including the execution of software stored on the computer-readable medium 1628. The software, when executed by the processor 1626, causes the power backoff system 1614 to perform the various functions described supra for any particular apparatus. The computer-readable medium 1628 may also be used for storing data that is manipulated by the processor 1626 when executing software. The power backoff system 1614 further includes the event analyzing module 1602 for analyzing an event combination of a first RAT event and a second RAT event, the power backoff module 1604 for determining a desired power backoff to improve performance of the event combination, the event occurrence module 1606 for recognizing an occurrence of the event combination, and the power backoff application module 1608 for electively apply the desired power backoff to the event combination The event analyzing module 1602, the power backoff module 1604, event occurrence module 1606, and the power backoff application module 1608 may be software modules running in the processor 1626, resident/stored in the computer readable medium 1628, one or more hardware modules coupled to the processor 1626, or some combination thereof. The power backoff system 1614 may be a component of the UE 250 and may include the memory 272 and/or the processor 270.

In one configuration, the user equipment 1600 for wireless communication includes means for analyzing an event, means for determining a desired power backoff, means for recognizing an occurrence of an event combination, and means for applying the desired power backoff to the event combination. The means may be the event analyzing module 1602, the power backoff module 1604, the event occurrence module 1606, the power backoff application module 1608, coexistence manager 640, processor 270, memory 272, antenna 252, transmitter/receiver 254, antenna 1620, transceiver 1622, processor 1626, computer readable medium 1628, and/or the power backoff system 1614 configured to perform the functions recited by the means. In another aspect, the aforementioned means may be any module or any apparatus configured to perform the functions recited by the aforementioned means.

The examples above describe aspects implemented in an LTE system. However, the scope of the disclosure is not so limited. Various aspects may be adapted for use with other communication systems, such as those that employ any of a variety of communication protocols including, but not limited to, CDMA systems, TDMA systems, FDMA systems, and OFDMA systems.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method for wireless communications for a multi-radio device, comprising:
analyzing an event combination of a first radio access technology (RAT) event and a second RAT event;
determining a desired power backoff to improve performance of the event combination;
recognizing an occurrence of the event combination; and
selectively applying the desired power backoff to the event combination.

2. The method of claim 1, in which the event combination comprises a plurality of events, each event comprising a communication operation and a frequency.

3. The method of claim 1, further comprising adjusting the desired power backoff.

4. The method of claim 3, in which adjusting the desired power backoff is based at least in part on communication timing of the first RAT and the second RAT.

5. The method of claim 1, in which the first RAT is Long Term Evolution (LTE) and the second RAT is Bluetooth.

6. The method of claim 5, in which the desired power backoff is applied to Bluetooth to reduce interference to LTE downlink when a Bluetooth transmission event overlaps in part with an LTE downlink sub-frame.

7. The method of claim 1, in which the desired power backoff is predetermined for the event combination.

8. An apparatus for wireless communications, comprising:
means for analyzing an event combination of a first radio access technology (RAT) event and a second RAT event;
means for determining a desired power backoff to improve performance of the event combination;
means for recognizing an occurrence of the event combination; and
means for selectively applying the desired power backoff to the event combination.

9. The apparatus of claim 8, in which the event combination comprises a plurality of events, each event comprising a communication operation and a frequency.

10. The apparatus of claim 8, further comprising means for adjusting the desired power backoff.

11. A computer program product for wireless communications, the computer program product comprising:
a non-transitory computer-readable medium having program code recorded thereon, the program code comprising:
program code to analyze an event combination of a first radio access technology (RAT) event and a second RAT event;
program code to determine a desired power backoff to improve performance of the event combination;
program code to recognize an occurrence of the event combination; and
program code to selectively apply the desired power backoff to the event combination.

12. The computer program product of claim 11, in which the event combination comprises a plurality of events, each event comprising a communication operation and a frequency.

13. The computer program product of claim 11, in which the program code further comprises program code to adjust the desired power backoff.

14. An apparatus for wireless communications, comprising:
a memory; and
at least one processor coupled to the memory, the at least one processor being configured:
to analyze an event combination of a first radio access technology (RAT) event and a second RAT event;
to determine a desired power backoff to improve performance of the event combination;
to recognize an occurrence of the event combination; and
to selectively apply the desired power backoff to the event combination.

15. The apparatus of claim 14, in which the event combination comprises a plurality of events, each event comprising a communication operation and a frequency.

16. The apparatus of claim 14 further comprising adjusting the desired power backoff.

17. The apparatus of claim 16 in which adjusting the desired power backoff is based at least in part on communication timing of the first RAT and the second RAT.

18. The apparatus of claim 14, in which the first RAT is Long Term Evolution (LTE) and the second RAT is Bluetooth.

19. The apparatus of claim 18, in which the desired power backoff is applied to Bluetooth to reduce interference to LTE downlink when a Bluetooth transmission event overlaps in part with an LTE downlink sub-frame.

20. The apparatus of claim 13, in which the desired power backoff is predetermined for the event combination.
